(19) United States
(12) Patent Application Publication
(10) Pub. No.: US 2024/0311694 A1
(43) Pub. Date: Sep. 19, 2024

(54) Method for configuring a data processing chain

(71) Applicant: ATOS France, BEZONS (FR)

(72) Inventors: Yannick LECROART, La Grande Motte (FR); Kamal AYOUBI, Montpellier (FR); Loïc MAISONNASSE, Mauguio (FR)

(73) Assignee: ATOS France, BEZONS (FR)

(21) Appl. No.: 18/600,982

(22) Filed: Mar. 11, 2024

(30) Foreign Application Priority Data
Mar. 15, 2023 (EP) 23305351.1

(51) Int. Cl. G06N 20/00; G06N 7/01

(52) U.S. Cl. CPC G06N 20/00; G06N 7/01

(57) ABSTRACT

The invention relates to a method for configuring a data processing chain (4) comprising a computing stage (10), the method comprising the steps of
determining an input signature of an input data stream (6);
computing a current similarity score between the input signature and a current signature associated with a training dataset of a current artificial intelligence model (12) implemented by the computing stage (10);
if the computed current similarity score is outside a predetermined acceptable range:
for each of at least one auxiliary artificial intelligence model (16), computing a corresponding auxiliary similarity score between the input signature and an auxiliary signature of an associated auxiliary training dataset;
configuring the computing stage (10) so as to implement the auxiliary artificial intelligence model (16) associated with the auxiliary signature that has the best auxiliary similarity score.

The present invention relates to a method for configuring a data processing chain, the processing chain comprising a computing stage for processing an input data stream.

The invention also relates to a computer program and to a device implementing such a method.

The invention applies to the field of connected objects, and in particular to the processing of data provided by such connected objects.

### STATE OF THE ART

In the field of connected objects (or IoT, “Internet of Things”), low-speed communication technologies such as the LoraWan (for “Long Range Wide-area network”) or NB-IoT (for “Narrow band Internet of Things”) protocols are well known.

It is also well known that, in this field, connected objects are likely to be subject to severe constraints, whether in terms of terrain (lack of optimal coverage, underground, interference, for example) or hardware (battery usage management and optimization, in particular).

As a result, the data transmitted by a group of connected objects to a data processing chain is likely to be very sparse.

Such a situation is not satisfactory.

In fact, the small amount of data uploaded by the group of connected objects means that an artificial intelligence model implemented in said processing chain to process said data is generally insufficiently trained. As a result, the performance of the artificial intelligence model is generally unsatisfactory. In particular, the low level of completeness of the data reported generally makes it impossible to predict temporal fluctuations in the data.

One aim of the present invention is to remedy at least one of these drawbacks.

Another aim of the invention is to propose a method for configuring a processing chain which gives said processing chain satisfactory performance, even in the event of a low abundance of data from a corresponding group of connected objects.

### DISCLOSURE OF THE INVENTION

To this end, the invention relates to a configuration method of the above-mentioned type, carried out by computer and comprising the steps of
determining an input signature of at least a portion of the input data stream;
computing a current similarity score, with regard to a predetermined similarity measure, between the determined input signature and a current signature, said current signature being associated with a current training data set on the basis of which a current artificial intelligence model implemented by the computing stage for said processing of the input data stream has been previously trained; and
if the computed current similarity score is outside a predetermined acceptable range:
for each of at least one auxiliary artificial intelligence model, each auxiliary artificial intelligence model having been previously trained based on an auxiliary training dataset having a corresponding auxiliary signature, computing a corresponding auxiliary similarity score between the input signature and the associated auxiliary signature;
configuring the computing stage so as to implement, for the processing of the input data stream, the auxiliary artificial intelligence model associated with the auxiliary signature which, on the one hand, has a better auxiliary similarity score with the input signature than the current signature and which, on the other hand, has the best auxiliary similarity score.

Indeed, the use of the similarity score allows the detection of a situation wherein properties of the input data deviate from the training data currently in use.

Furthermore, the pre-training of a plurality of artificial intelligence models, on the basis of auxiliary training datasets with varying properties, produces a plurality of models that can be implemented in the event of such a deviation occurring.

More precisely, the method according to the invention allows the current artificial intelligence model to be replaced by the auxiliary artificial intelligence model for which the auxiliary training dataset has the greatest similarity to the data currently being received from the connected objects. In other words, the overall performance of the processing chain will not significantly be affected by the deviation mentioned above, insofar as the performance of the auxiliary artificial intelligence model is probably better than those of the current artificial intelligence model for these new data.

Advantageously, the method according to the invention has one or more of the following characteristics, taken individually or in any technically possible combination:
the input signature is determined, at any given current moment, from the input data received in a time window of predetermined duration preceding the current moment;
the input signature is a probability distribution of the input data;
the current signature is a probability distribution of the data of the current training data set;
the auxiliary signature is a probability distribution of the data in the auxiliary training dataset;
the current similarity score is the p-value under the null hypothesis “the input signature is identical to the current signature”, and the auxiliary similarity score is the p-value under the null hypothesis “the auxiliary signature is identical to the current signature”;
the current similarity score, respectively the auxiliary current similarity score, is:
the result of a Student's t-test on the current signature, respectively on the auxiliary signature;
the result of a Wilcoxon-Mann-Whitney test representative of proximity between the current signature, respectively the auxiliary signature, and the input signature; or
the result of a Kolmogorov-Smirnov test representative of proximity between the current signature, respectively the auxiliary signature, and the input signature;
the method further comprises the steps of:
synthesizing, from the input data, of at least one synthetic dataset; and
for each synthetic dataset, training an artificial intelligence model on the basis of said synthetic dataset to generate an additional auxiliary artificial intelligence model;
the synthesis step comprises the phases of:
determining a probability distribution of at least a portion of the input data stream;
modifying at least one parameter of the determined probability distribution to create at least one synthetic probability distribution; and
for each created synthetic probability distribution, generating, in accordance with said created synthetic probability distribution, a plurality of values forming a synthetic dataset.

According to another aspect of the invention, a computer program is proposed which comprises executable instructions that, when executed by computer, implement the steps of the method as defined hereinbefore.

The computer program can be in any computer language, such as for example machine language, C, C++, JAVA, Python, etc.

According to another aspect of the invention, a device for configuring a data processing chain is proposed, the processing chain comprising a computing stage for processing an input data stream,
the configuring device being configured to:
   determine an input signature of at least a portion of the input data stream;
   compute a current similarity score, with regard to a predetermined similarity measure, between the determined input signature and a current signature, said current signature being associated with a current training data set on the basis of which a current artificial intelligence model implemented by the computing stage for said processing of the input data stream has been previously trained; and
   if the computed current similarity score is outside a predetermined acceptable range:
   for each of at least one auxiliary artificial intelligence model, each auxiliary artificial intelligence model having been previously trained based on an auxiliary training dataset having a corresponding auxiliary signature, compute a corresponding auxiliary similarity score between the input signature and the associated auxiliary signature;
   configure the computing stage so as to implement, for the processing of the input data stream, the auxiliary artificial intelligence model associated with the auxiliary signature which, on the one hand, has a better similarity score with the input signature than the current signature and which, on the other hand, has the best similarity score.

The device according to the invention can be any type of device such as a server, a computer, a tablet, a calculator, a processor, a computer chip, programmed to implement the method according to the invention, for example by executing the computer program according to the invention.

### BRIEF DESCRIPTION OF THE FIGURES

The invention will be better understood on reading the following description, given solely by way of non-limiting example and with reference to the accompanying drawings, wherein:

FIG. 1 is a schematic depiction of a configuring device according to the invention;

FIG. 2 is a flowchart of a configuring method implemented by the configuring device of FIG. 1.

It is understood that the embodiments which will be described hereinafter are in no way limiting. It will in particular be possible to imagine variants of the invention comprising only a selection of features described below isolated from the other features described, if this selection of features is sufficient to confer a technical advantage or to differentiate the invention from the prior art. This selection comprises at least one preferably functional feature without structural details, or with only a part of the structural details if this part is only sufficient to confer a technical advantage or to differentiate the invention from the prior art.

In particular, all the variants and all the embodiments described can be combined with one another, provided there are no technical obstacles to such combination.

In the figures and in the rest of the description, the elements common to multiple figures retain the same reference.

### DETAILED DESCRIPTION

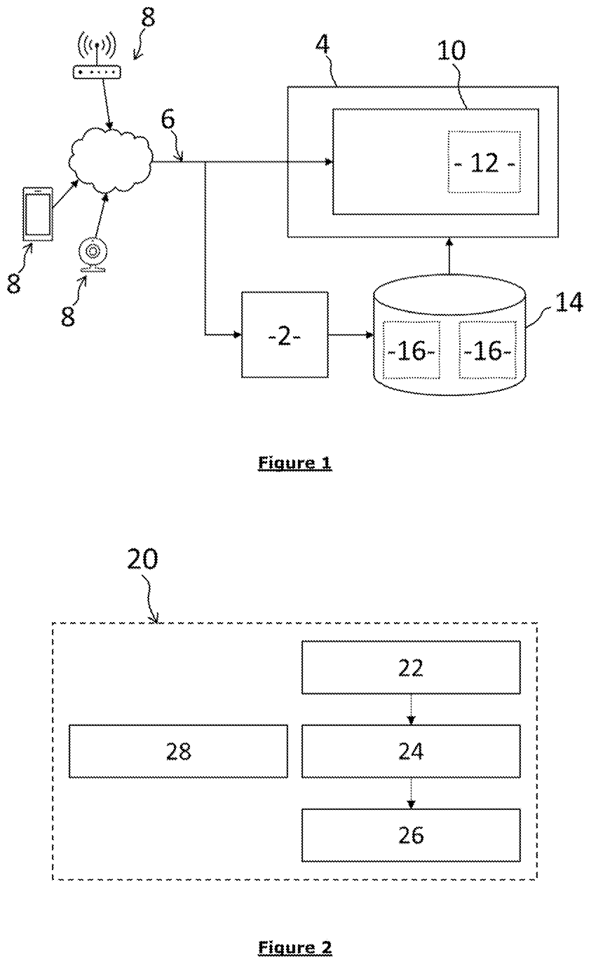

A configuring device 2 according to the invention, for the configuring of a data processing chain 4 (subsequently called the “processing chain”), is shown by FIG. 1.

The processing chain 4 is configured to process a input data stream 6 received from at least one source 8, in particular from at least one connected object.

More specifically, the processing chain 4 comprises a computing stage 10 suitable for, in operation, implementing a current artificial intelligence model 12 for processing the input data stream 6.

The current artificial intelligence model 12 was previously trained on the basis of a corresponding training dataset, referred to as “current”. Such a current training dataset is associated with a respective current signature, described through an example in what follows.

Furthermore, the processing chain 4 is associated with a memory 14 configured to store at least one artificial intelligence 16 model, referred to as “auxiliary”.

Each auxiliary artificial intelligence model 16 was previously trained on the basis of a training dataset, referred to as “auxiliary”. Furthermore, each auxiliary training dataset is associated with a respective auxiliary signature, described below through an example.

The configuring device 2 is intended to modify a configuration of the processing chain 4, and more particularly of its computing stage 10. More specifically, the configuring device 2 is intended to modify the configuration of the processing chain 4 according to the current characteristics of the input data stream 6.

The configuring device 2 may be in hardware form, such as a computer, a server, a processor, an electronic chip, etc. Alternatively, or additionally, the configuring device 2 may be in software form, such as a computer program, or an application, for example an application for a user device such as a tablet or smartphone.

To carry out such configuring, the configuring device 2 is configured to implement a configuring method 20, schematically shown by FIG. 2.

As appears in this figure, the configuring method 20 comprises a step 22 of determining an input signature, successive steps 24 of computing similarity and of configuration 26.

Optionally, the configuring method 20 also comprises an enrichment step 28.

### Determining the Input Signature

The configuring device 2 is configured to read the input data of the input data stream 6.

Furthermore, the configuring device 2 is configured to determine, during the input signature determination step 22, an input signature of at least part of the input data stream 6.

Preferably, at any given current moment, the configuring device 2 is configured to determine the input signature from the input data received in a time window of predetermined duration preceding the current moment. Such a duration depends in particular on the use case, in particular on an expected frequency of sending data by the sources 8. For example, depending on the use case, the predetermined duration is a week, or even a month, or even a day.

More preferably, the configuring device 2 is configured to determine the input signature as being a probability distribution of the input data. For example, the configuring device 2 is configured to determine whether the input data are governed by a Poisson distribution or Gaussian distribution, and, if applicable, to estimate the parameters thereof (expectation and/or variance, for example). More generally, the choice of the probability distribution depends on the use case and on the type of sources 8, in particular on their programming (on battery or not) and/or on the size of the data received, in particular when it is placed opposite the data upload frequency (per second, per minute, hourly, weekly, monthly, etc.) and the number of observations.

### Computing Similarity

Furthermore, the configuring device 2 is configured to compute, during the step 24 of computing similarity, a current similarity score between the determined input signature and the current signature.

In the case where the input signature is the probability distribution of the input data, preferably, the current signature is a probability distribution of the data of the current training dataset based on which the current artificial intelligence model 12 has been trained.

More specifically, the configuring device 2 is configured to compute the current similarity score with respect to a predetermined similarity measure.

Preferably, in the case where each signature is a probability distribution, the current similarity score is the p-value under the null hypothesis: “the input signature is identical to the current signature”. Such a p-value, known to the person skilled in the art, is defined as the probability of observing a dataset under the null hypothesis.

Alternatively, the current similarity score is the result of a Student's t-test, known per se, that is, a test wherein the null hypothesis is true if the current signature is a Student's t-distribution. Such a test is, for example, implemented when it is determined that the input data are governed by a Student's t-distribution.

According to another variant, the current similarity score is the result of a Wilcoxon-Mann-Whitney test, known per se. More specifically, in this case, the result quantifies a proximity between the probability distribution of the data of the current training data set (that is the current signature) and the probability distribution of the input data (that is the input signature).

Alternatively, the current similarity score is the result of a Kolmogorov-Smirnov test, known per se. In this case, the result is representative of a proximity between the probability distribution of the data of the current training dataset and the probability distribution of the input data.

The configuring device 2 is also configured to determine whether the computed current similarity score is within a predetermined acceptable range or not.

For example, in the case where the current similarity score is the p-value under the null hypothesis “the input signature is identical to the current signature”, the configuring device 2 is configured to determine whether the computed current similarity score is greater than 0.1.

### Configuration

Furthermore, the configuring device 2 is configured to compute an auxiliary similarity score for each auxiliary artificial intelligence model 16, if it has been determined that the computed current similarity score is outside the acceptable range.

More specifically, for each auxiliary artificial intelligence model 16, the configuring device 2 is configured to compute the corresponding auxiliary similarity score as being a similarity score between the associated auxiliary signature and the input signature.

Preferably, the auxiliary similarity score is computed similarly to the current similarity score described above, the data of the auxiliary training dataset replacing the data of the current training dataset.

In the case where the input signature is the probability distribution of the input data, preferably, for each auxiliary artificial intelligence model 16, the corresponding auxiliary signature is a probability distribution of the data of the auxiliary training dataset based on which said auxiliary artificial intelligence model 16 has been trained.

Furthermore, if there is at least one auxiliary signature having a better similarity score with the input signature that the current signature, then the configuring device 2 is adapted to configure the computing stage 10 so that said computing stage 10 implements, for the processing of the input data stream 6, the auxiliary artificial intelligence model 16 associated with the auxiliary signature that has the best similarity score.

For example, in the case where the current similarity score is the value p under the null hypothesis “the input signature is identical to the current signature”, the configuring device 2 is adapted to configure the computing stage 10 so as to implement the auxiliary artificial intelligence model 16 associated with the auxiliary signature for which the p-value is greatest.

### Enrichment

Optionally, the configuring device 2 is configured to, during the enrichment step 28, synthesize at least one synthetic dataset from all or part of the data of the input data stream 6.

Preferably, in order to perform such a synthesis, the configuring device 2 is configured to determine a probability distribution of at least part of the input data, for example the input data received during a predetermined time interval preceding a current moment.

The configuring device 2 is also configured so as to modify at least one parameter of the determined probability distribution to create at least one synthetic probability distribution. For example, the at least one parameter of the created synthetic probability distribution is determined so as to maximize a probability of observing the received input data (maximum likelihood) during the predetermined time interval. One advantage is that the synthetic probability distribution makes it possible to characterize a change in statistical properties of the input data received during a transition period.

Furthermore, for each created synthetic probability distribution, the configuring device 2 is configured to generate a plurality of values according to said synthetic probability distribution: the values thus generated form a synthetic dataset. These synthetic data are for example obtained by resampling or sub-sampling the input data, from the synthetic probability distribution. They contribute to expanding a dataset available for the training of an artificial intelligence model and therefore to compensate for the low level of completeness of the data uploaded by the sensors.

Furthermore, for each synthetic dataset, the configuring device 2 is configured to control the processing chain 4 so that it trains an artificial intelligence model based on said synthetic dataset. This results in an additional auxiliary artificial intelligence model 16. One advantage is that it is adapted to the statistical properties of the data received during the predetermined time interval. When it is implemented during a transition period, or when a new phenomenon appears, this enrichment step 28 therefore makes it possible to anticipate temporal fluctuations that the current artificial intelligence model or even the available auxiliary artificial intelligence models are unable to predict. They will thus be better detected in the future and processed more effectively by a specifically generated auxiliary artificial intelligence model.

Alternatively, for each synthetic dataset, the configuring device 2 is configured to itself train an artificial intelligence model based on said synthetic dataset, so as to generate an additional auxiliary artificial intelligence model 16.

Preferably, the configuring device 2 commands the storage, in the memory 14, of the generated additional auxiliary artificial intelligence model 16.

The enrichment step 28 is, for example, implemented parallel to the steps of input signature determination, similarity computing, and configuration.

### Operation

The operation of the configuring device 2 will now be described.

During its operation, the configuring device 2 receives the input data stream 6, and implements, for example continuously, the input signature determination step 22 and the similarity computing step 24.

More specifically, during the input signature determination step 22, the configuring device 2 reads the input data from the input data stream 6, and determines the input signature of at least part of the input data stream 6.

Then, during the similarity computing step 24, the configuring device 2 computes the current similarity score between the determined input signature and the current signature.

If the computed current similarity score is outside the predetermined acceptable range, then the configuring device 2 implements the configuration step 28.

More specifically, during the configuration step 28, the configuring device 2 computes, for each auxiliary artificial intelligence model 16, the corresponding auxiliary similarity score between the associated auxiliary signature and the input signature.

Furthermore, if there is at least one auxiliary signature having a better similarity score with the input signature that the current signature, then the configuring device 2 configures the computing stage 10 so that said computing stage 10 implements, for the processing of the input data stream 6, the auxiliary artificial intelligence model 16 associated with the auxiliary signature that has the best similarity score.

Furthermore, during the enrichment step 28, parallel or not to the above-mentioned steps 22, 24 and 26, the configuring device 2 also synthesizes at least one synthetic dataset from the input data.

Then, for each synthetic dataset, the configuring device 2 commands the training of an artificial intelligence model based on said synthetic dataset, so as to generate an additional auxiliary artificial intelligence model 16.

The additional auxiliary artificial intelligence model thus generated is then stored in the memory 14.

Of course, the invention is not limited to the examples that have just been described.

1. A method (20) for configuring a data processing chain (4), the processing chain (4) comprising a computing stage (10) for processing an input data stream (6), the method being carried out by computer and comprising:
determining (22) an input signature of at least a portion of the input data stream (6);
computing (24) a current similarity score, with regard to a predetermined similarity measure, between the determined input signature and a current signature, said current signature being associated with a current training data set on the basis of which a current artificial intelligence model (12) implemented by the computing stage (10) for said processing of the input data stream (6) has been previously trained; and
if the computed current similarity score is outside a predetermined acceptable range:
for each of at least one auxiliary artificial intelligence model (16), each auxiliary artificial intelligence model (16) having been previously trained based on an auxiliary training dataset having a corresponding auxiliary signature, compute a corresponding auxiliary similarity score between the input signature and the associated auxiliary signature; and
configuring (26) the computing stage so as to implement, for the processing of the input data stream, the auxiliary artificial intelligence model (16) associated with the auxiliary signature which, on the one hand, has a better auxiliary similarity score with the input signature than the current signature and which, on the other hand, has the best auxiliary similarity score.

2. The method (20) according to claim 1, wherein the input signature is determined, at any given current moment, from the input data received in a time window of predetermined duration preceding the current moment.

3. The method (20) according to claim 1, wherein:
the input signature is a probability distribution of the input data;
the current signature is a probability distribution of the data of the current training data set; and/or
the auxiliary signature is a probability distribution of the data in the auxiliary training dataset.

4. The method (20) according to claim 3, wherein the current similarity score is the p-value under the null hypothesis “the input signature is identical to the current signature”, and the auxiliary similarity score is the p-value under the null hypothesis “the auxiliary signature is identical to the current signature”.

5. The method (20) according to claim 3, wherein the current similarity score, respectively the auxiliary similarity score, is:
the result of a Student's t-test on the current signature, respectively on the auxiliary signature;
the result of a Wilcoxon-Mann-Whitney test representative of proximity between the current signature, respectively the auxiliary signature, and the input signature; or
the result of a Kolmogorov-Smirnov test representative of proximity between the current signature, respectively the auxiliary signature, and the input signature.

6. The method (20) according to claim 1, further comprising the steps of:
synthesizing, from the input data, of at least one synthetic dataset; and
for each synthetic dataset, training an artificial intelligence model on the basis of said synthetic dataset to generate an additional auxiliary artificial intelligence model.

7. The method (20) according to claim 6, wherein the synthesis step comprises the phases of:
determining a probability distribution of at least a portion of the input data stream;
modifying at least one parameter of the determined probability distribution to create at least one synthetic probability distribution; and
for each created synthetic probability distribution, generating, in accordance with said created synthetic probability distribution, a plurality of values forming a synthetic dataset.

8. A computer program comprising executable instructions which, when they are executed by computer, implement the steps of the method according to claim 1.

9. A device (2) for configuring a data processing chain (4), the processing chain (4) comprising a computing stage (10) for processing an input data stream (6), the device (2) being configured to:
determine an input signature of at least a portion of the input data stream (6);
compute a current similarity score, with regard to a predetermined similarity measure, between the determined input signature and a current signature, said current signature being associated with a current training data set on the basis of which a current artificial intelligence model (12) implemented by the computing stage (10) for said processing of the input data stream (6) has been previously trained; and
if the computed current similarity score is outside a predetermined acceptable range:
for each of at least one auxiliary artificial intelligence model (16), each auxiliary artificial intelligence model (16) having been previously trained based on an auxiliary training dataset having a corresponding auxiliary signature, compute a corresponding auxiliary similarity score between the input signature and the associated auxiliary signature; and
configure the computing stage (10) so as to implement, for the processing of the input data stream (6), the auxiliary artificial intelligence model (16) associated with the auxiliary signature which, on the one hand, has a better similarity score with the input signature than the current signature and which, on the other hand, has the best similarity score.
